(19) United States
(12) Patent Application Publication
(10) Pub. No.: US 2015/0170184 A1
(43) Pub. Date: Jun. 18, 2015

(54) METHOD FOR PROVIDING ADVERTISEMENT SERVICE BASED ON CALL

(71) Applicant: Min-Soo KIM, Seoul (KR)

(72) Inventor: Min-Soo KIM, Seoul (KR)

(21) Appl. No.: 14/569,877

(22) Filed: Dec. 15, 2014

(30) Foreign Application Priority Data
Dec. 16, 2013 (KR) 10-2013-0156280

(51) Int. Cl. G06Q 30/02

(52) U.S. Cl. CPC G06Q 30/0226; G06Q 30/0257; G06Q 30/0267; G06Q 30/0269; G06Q 30/0272

(57) ABSTRACT

A call-based advertisement service-providing method is provided, and this method includes a step where signal based on incoming call or outgoing call is received from at least one terminal; a step where advertisement databases are arrayed based on information about a user of the at least one terminal; s step where the arrayed advertisement databases are transmitted to the at least one terminal to which the incoming call or outgoing call has been transmitted and the advertisement based on the advertisement databases is displayed on the at least one terminal; and a step where a first reward point is provided to the at least one terminal on which the advertisement has been displayed. In this connection, the information about the user includes at least one of area, gender, age, marital status, preferred movie, preferred goods, and preferred service article.

### TECHNICAL FIELD

The present invention relates to a call-based advertisement service-providing method.

### BACKGROUND ART

In recent, there is a trend that an advertisement medium is extended to an application as a reward advertisement application is invigorated, and most of advertisers want to insert their advertisement images in various functions of a smartphone to thereby achieve an advertisement effect.

At this time, a method of providing a reward advertisement application is such that the application is installed in a mobile terminal and the reward is provided when actions already set are performed. In this connection, Korean Laid-Open Application No. 2012-0106219 (2012 Sep. 26) of prior art discloses a method where a reward is provided when a certification code transmitted by an application coincides with certification code stored in a server and actions already set in the application are performed.

However, if a user thinks that a process itself of performing certain actions through the application is bothersome, a probability of deletion of the relevant application may be increased, and there is a tendency that a rate of use by user is drastically reduced when certain actions are required, and thus, in the majority of case, continual use is impossible.

### SUMMARY OF THE INVENTION

### Technical Problems

An embodiment of the present invention can provide a call-based advertisement service-providing method which can minimize user's feeling of repulsion toward an advertisement by inserting the advertisement in stages of call-sending, call-receiving, calling and call-ending ordinarily used. However, technical problem to be solved by the embodiment is not limited to the above-mentioned problem and thus other technical problems may be present.

### Solution to the Problem

As technical means for achieving the above-mentioned technical problem, an embodiment of the present invention includes a step where signal based on incoming call or outgoing call is received from at least one terminal; a step where advertisement databases are arrayed based on information about a user of the at least one terminal; s step where the arrayed advertisement databases are transmitted to the at least one terminal to which the incoming call or outgoing call has been transmitted and the advertisement based on the advertisement databases is displayed on the at least one terminal; and a step where a first reward point is provided to the at least one terminal on which the advertisement has been displayed. In this connection, the information about the user includes at least one of area, gender, age, marital status, preferred movie, preferred goods, and preferred service article.

### Effects of the Invention

According to the above-described solution to the problem, since the reward points for the advertisement can be accumulated even without separate operations by the user, damage caused to the user can be minimized, and accordingly continual use of a call-based advertisement service program can be ensured.

### BRIEF DESCRIPTION OF THE DRAWINGS

FIG. 1 is a constructional view for describing a call-based advertisement service-providing system according to an embodiment of the present invention;

FIG. 2 is a constructional view for describing a call-based advertisement service-providing server illustrated in FIG. 1;

FIG. 3 is a view illustrating an embodiment in which the call-based advertisement service is realized in at least one terminal illustrated in FIG. 1;

FIG. 4 is a view showing a process in which data is transmitted and received between components included in the call-based advertisement service-providing system of FIG. 1 according to an embodiment of the present invention; and

FIG. 5 is an operational flowchart for describing the call-based advertisement service-providing method according to an embodiment of the present invention.

### BEST MODES FOR CARRYING OUT THE INVENTION

In the following, referring to the attached drawings, an embodiment of the present invention will be described in detail so that those skilled in the art can easily carry out the present invention. However, the present invention may be embodied in various different forms and is not limited to the embodiment described herein. Furthermore, parts having no relation with description are omitted for the sake of clear description of the present invention, and similar parts are designated by similar reference numerals throughout the specification.

Throughout the specification, when referring to ┌a part is “connected” with another part┐, it includes not only a case of “being directly connected” but also a case of “being electrically connected with another element interposed between the two parts”. Furthermore, when referring to ┌a part “includes” a component┐, it means that the part does not exclude another components and rather may further include another components unless specifically otherwise stated, and it should be understood that a possibility is not previously excluded of the presence or addition of one or more another feature, number, step, action, element, part or combination thereof.

In the following, referring to the attached drawings, the present invention will be described in detail.

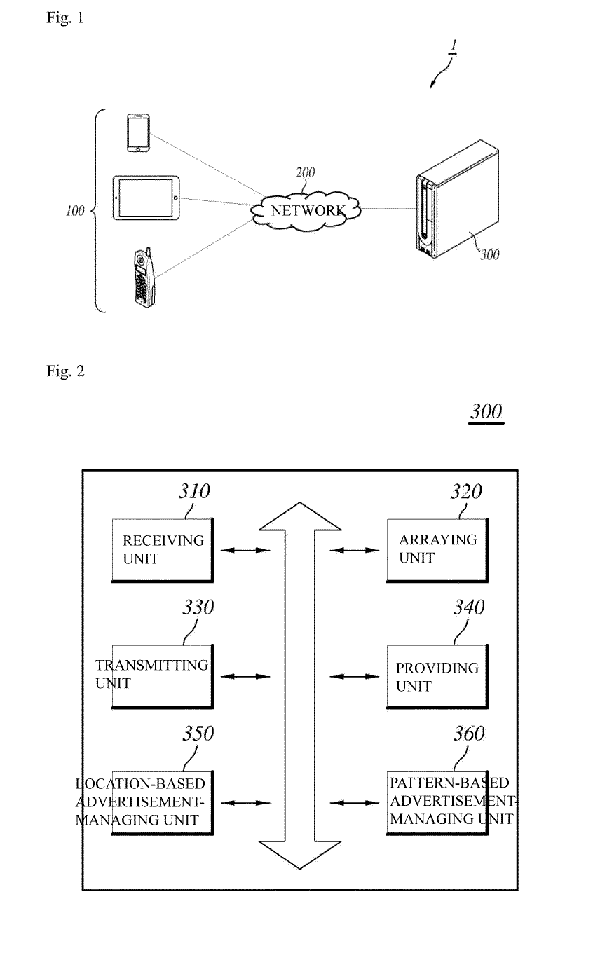

FIG. 1 is a constructional view for describing a call-based advertisement service-providing system according to an embodiment of the present invention. Referring to FIG. 1, the call-based advertisement service-providing system (1) may include at least one terminal (100) and a call-based advertisement service-providing server (300). However, such a call-based advertisement service-providing system (1) in FIG. 1 is merely one embodiment of the present invention, and thus the present invention should not be construed to be limited by FIG. 1.

At this time, components of FIG. 1 are usually each connected through a network (200). For example, as illustrated in FIG. 1, the at least one terminal (300) and the call-based advertisement service-providing server (300) may be connected through the network (200). Herein, the network (200) means a connection structure which allows information exchange between nodes such as terminals and servers, and example of such a network (200) includes Internet, LAN (Local Area Network), Wireless LAN (Wireless Local Area Network), WAN (Wide Area Network), PAN (Personal Area Network), 3G, 4G, LTE, Wi-Fi etc., but is not limited to them. The at least one terminal (100) and the call-based advertisement service-providing server (300) illustrated in FIG. 1 should not be construed to be limited to those illustrated in FIG. 1.

The at least one terminal (100) may be a terminal which uses the call-based advertisement service by connection to the call-based advertisement service-providing server (300). Furthermore, the at least one terminal (100) may be a terminal which outputs the call-based advertisement service when outgoing call or incoming call is generated. Also, the at least one terminal (100) may be a terminal which outputs the call-based advertisement service after generation of the outgoing call until the outgoing call is ended or after generation of the incoming call until the incoming call is ended. Furthermore, the at least one terminal (100) may be a terminal which outputs the call-based advertisement service after the outgoing call or incoming call is ended. Furthermore, the at least one terminal (100) may be a terminal which provides reward point to a user using the at least one terminal (100) after the incoming call or outgoing call is ended. Also, the at least one terminal (100) may transmit information about the user using the at least one terminal (100) by connection to the call-based advertisement service-providing server (300), wherein the information about the user may be periodically updated upon request of the at least one terminal (100) or call-based advertisement service-providing server (300). In this connection, the at least one terminal (100) may be embodied as a computer which can be connected to a remote server or terminal through the network (200). Herein, example of the computer may include a notebook, a desktop, laptop etc. with web browser installed therein.

The call-based advertisement service-providing server (300) may be a server which provides the call-based advertisement service to the at least one terminal (100). Furthermore, the call-based advertisement service-providing server may be a server which learns information about the user of the at least one terminal (100) and thus provides optimized effective advertisement to the user of the at least one terminal (100). And, the call-based advertisement service-providing server (300) may grasp the location of the at least one terminal (100) by using GPS or by indirect estimation method using the location of a relay or base station connected to the at least one terminal (100) and can transmit advertisement meeting all of the grasped location and the information about the user to the at least one terminal (100). In this connection, the indirect estimation method using the location of the relay may utilize a 3-point method for example. Herein, the 3-point method may be a method where three points are grasped by using the relay or base station connected to the at least one terminal (100) and RSSI (Received Signal Strength Indicator) of at least two relays or base stations which the at least one terminal (100) senses. Then, the three points are connected in the form of triangle, and thus the at least one terminal (100) can be grasped through the connected points. Furthermore, an indirect estimation method using the location of Wi-Fi may be used. In the indirect estimation method using the location of WIFI, connection request for connection to Wi-Fi is broadcast to at least one Wi-Fi from the at least one terminal (100), and response message received from the at least one Wi-Fi as a response of broadcast can be transmitted to the call-based advertisement service-providing server (300) from the at least one terminal (100). At this time, the call-based advertisement service-providing server (300) may read header of the response message and grasp the address of the at least one Wi-Fi, and may know address of the grasped Wi-Fi and physical address of mapped Wi-Fi. Also at this time, the call-based advertisement service-providing server (300) may likewise at least connect vertices of the triangle by using the RSSI and estimate the location of the at least one terminal (100). At this time, the call-based advertisement service-providing server (300) may be embodied as a computer which can be connected to a remote server or terminal through the network (200). Herein, example of the computer may include a notebook, a desktop, laptop etc. with web browser installed therein.

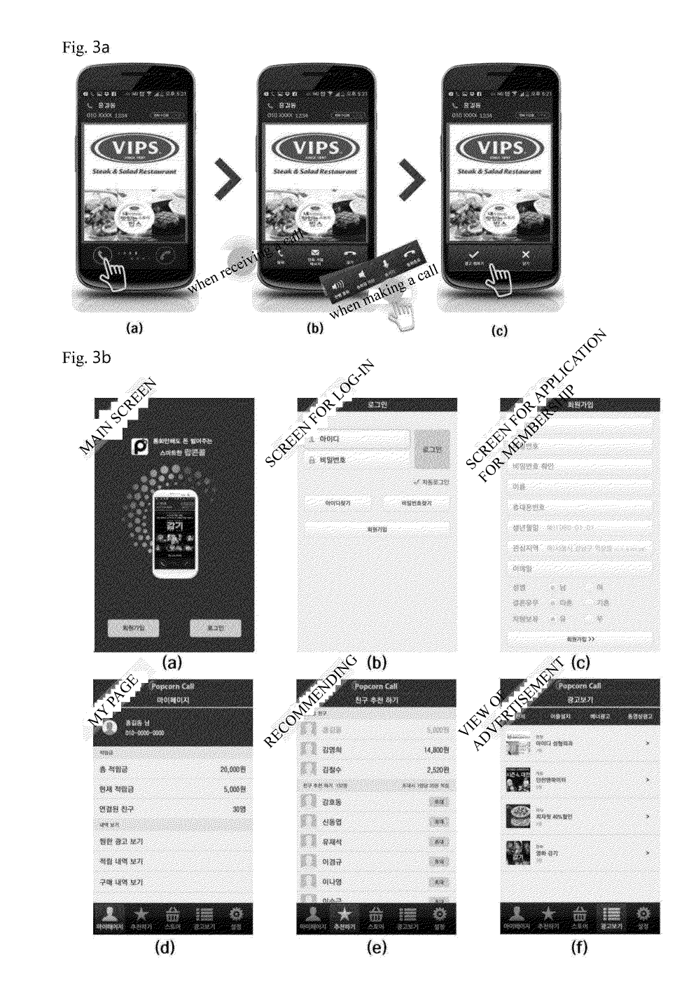

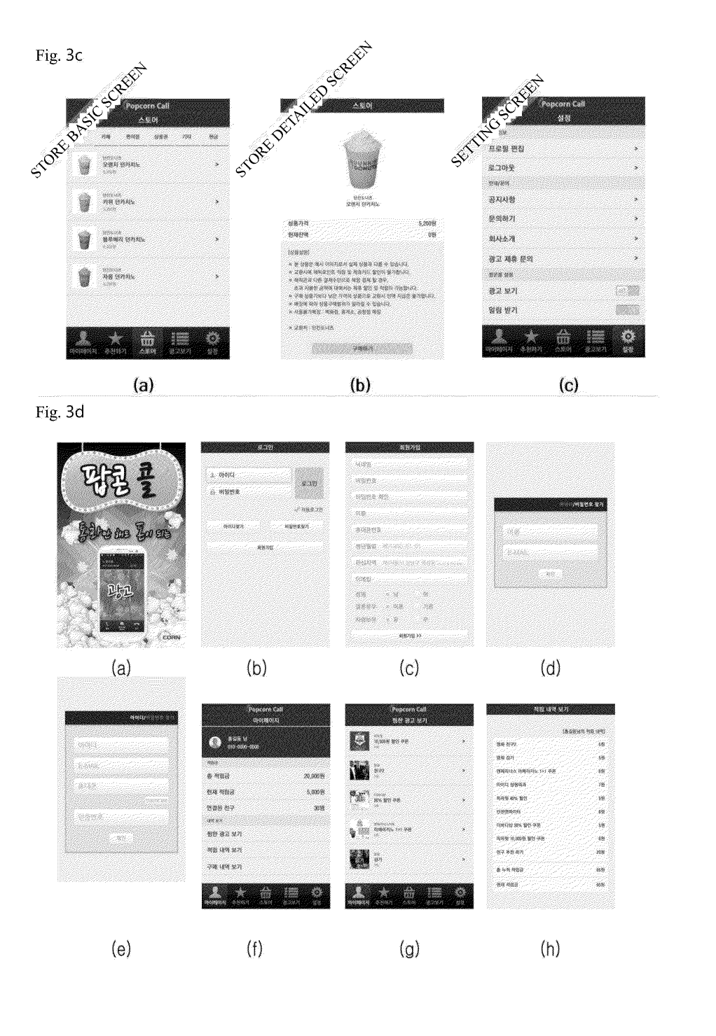

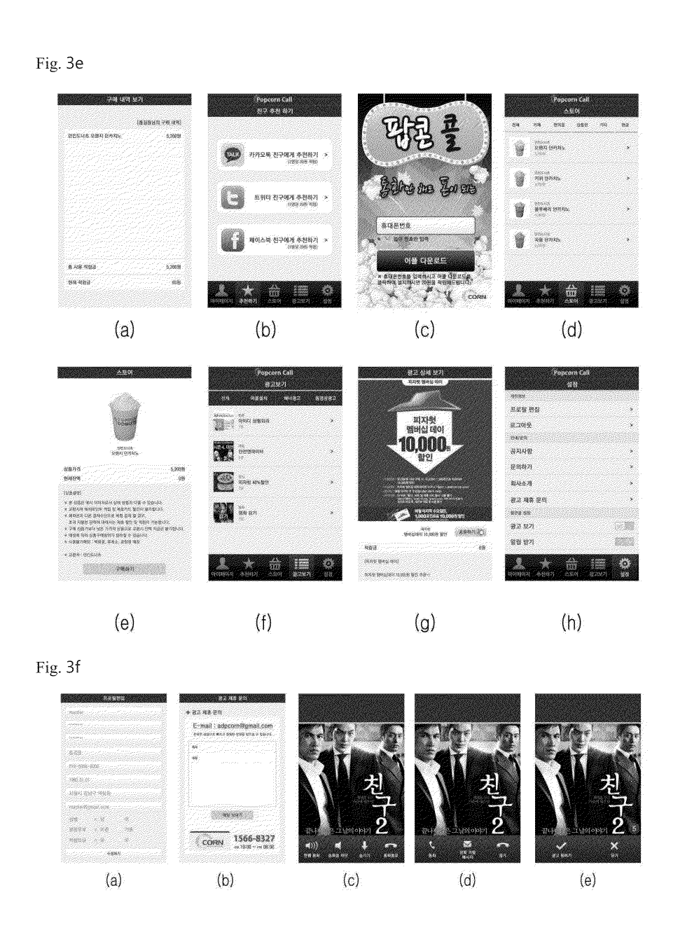

FIG. 2 is a constructional view for describing the call-based advertisement service-providing server illustrated in FIG. 1, and FIG. 3 is a view illustrating an embodiment in which the call-based advertisement service is realized in the at least one terminal illustrated in FIG. 1.

Referring to FIG. 2, the call-based advertisement service-providing server (300) may include a receiving unit (310), an arraying unit (320), a transmitting unit (330), a providing unit (340), a location-based advertisement-managing unit (350), and a pattern-based advertisement-managing unit (360).

If the call-based advertisement service-providing server (300) according to an embodiment of the present invention or another server (not shown) operated in association with the call-based advertisement service-providing server (300) transmits an application, program, webpage etc. for reward advertisement service to the at least one terminal (100), the at least one terminal (100) can install or open the application, program, webpage etc. for a relevant service. Furthermore, the service program may be driven in the at least one terminal (100) by using script implemented in the web browser. Herein, the web browser means a program which enables using of WWW (World Wide Web) service and which receives and shows hyper text described by HTML (hyper text mark-up language). Example of the web browser includes Netscape, Explorer, chrome and the like. Furthermore, the application means an applied program in the terminal and includes, for example, app implemented in mobile terminal (smartphone).

In this connection, the connection to the network (200) means creation of communication object at communication contact point for communication between the at least one terminal (100) and the call-based advertisement service-providing server (300) connected to the terminal through the network (200). The call-based advertisement service-providing server (300) may exchange data through the communication object.

The receiving unit (310) may receive signal based on the incoming call or outgoing call from the at least one terminal (100). At this time, the receiving unit (310) is operated in association with the base station for connection of the at least one terminal (100), and may receive, together with the at least one terminal (100), the incoming call or outgoing call generated from the at least one terminal (100). The receiving unit (310) may extract information about the location of the base station from which the outgoing call or incoming call is generated, by analyzing information contained in the outgoing call or incoming call.

The arraying unit (320) may array advertisement database based on the information about the user of the at least one terminal (100). In this connection, the information about the user may include at least one of area, gender, age, marital status, preferred movie, preferred goods, and preferred service article. In this connection, the area may not be only address of the at least one terminal (100) but also current location of the at least one terminal (100). The current location may be a location grasped by using GPS or indirectly grasped through the location of the base station or the relay for relaying the outgoing call or incoming call when GPS is not activated in the at least one terminal (100). And, the preferred movie may be grasped through preferred entertainer, preferred genre, preferred director and the like, and the user may give weight to any parameter of the three parameters. Array is made in the order of the sum of the given weights; if the sum of the weights is equal, the array may be made in the order of movie in which a parameter having the greatest weight is present. Furthermore, the preferred goods mean all articles bearing the trademark, and the preferred service article may mean all articles produced on the spot.

The transmitting unit (330) may transmit arrayed advertisement database to the at least one terminal (100) to which the incoming call or outgoing call has been transmitted. Accordingly, advertisement based on advertisement database may be displayed on the at least one terminal (100). At this time, the advertisement service may be provided by that the application installed in the at least one terminal (100) registers a advertisement service-receiving receiver in OS(Operating System) of the at least one terminal (100) and that whenever advertisement database-receiving event is generated, the application receives the advertisement database and that whenever the incoming call or outgoing call is generated, at least one advertisement of the advertisements contained in the received advertisement database is displayed.

The providing unit (340) may provide a first reward point to the at least one terminal (100) on which the advertisement is displayed. In this connection, when the incoming call or outgoing call has been ended, the at least one terminal (100) may output a user interface for selecting the advertisement displayed while the incoming call or outgoing call proceeds. In this connection, the at least one terminal (100) may provide a second reward point when the output user interface has been selected, and log data based on the provided reward point may be transmitted to the call-based advertisement service-providing server (300) and stored while mapped with the at least one terminal (100). In this connection, the second reward point may be greater than the first reward point. For example, If it is assumed that one point is provided when only advertisement is output from the at least one terminal (100) and the advertisement is not selected by the user, two points may be provided when the advertisement is selected by the user. In this connection, the providing unit (340) may increase the first reward point based on at least one of period, number, rate of use of the advertisement service by the user of the at least one terminal (100). For example, if the period of use is long, the number of use is great or the rate of use (the rate of use per day, the rate of use per week, the rate of use per month and the like) is high, the first reward point may be proportionally increased. For example, if the first reward point is set as “2” for initial user, as any one of the number, period, rate of use by the relevant user is increased, two reward points are increased to three reward points, which are in turn increased to four reward points.

The location-based advertisement-managing unit (350), the advertisement service-providing server (300) receiving collected information about the location can extract advertisement databases matching with the information about the user from advertisement databases having the collected information about the location and array the advertisement databases in the at least one terminal (100). Furthermore, the location-based advertisement-managing unit (350) may list the arrayed advertisement databases matching with the information about the user in the order of priority and then transmit the advertisement databases to the at least one terminal (100). For example, it is assumed that the collected information about the location is Myoung-Dong, current time is 7 p.m. and a learned user's pattern information for 7 p.m. is to have a meal and the user's preferred service article is hot food. At this time, the location-based advertisement-managing unit (350) may transmit an advertisement database tagged with Myoung-Dong and hot food to the at least one terminal (100). At this time, the type of tag may be variously set, but a result meeting all of the information about the location and the information about the user is output while “Myoung-Dong” and “hot food” are included together in an operator. For example, the advertisement database may be filtered and arrayed through the operator “(Myoung-Dong) AND (hot OR hot food OR spicy OR SPICY OR HOT)”. At this time, the at least one terminal (100) may collect the information about the location of the relay, Wi-Fi device and base station connected to the at least one terminal and transmit the collected information about the location to the advertisement service-providing server (300).

In this connection, the at least one terminal (100) may include a user interface for setting an exposure time of the advertisement service based on the advertisement database. In this connection, the at least one terminal (100) may not expose the advertisement service based on the advertisement database while the outgoing call or incoming call proceeds, for remaining time except the set exposure time. For example, a user A sets the exposure time in such a manner that the advertisement service is not exposed for a period of time of intensive working, e.g. from 8 to 12 a.m. or from 2 to 6 p.m., the at least one terminal (100) may allow the advertisement service to be activated for remaining time except the relevant time.

Furthermore, the application installed in the at least one terminal (100) may be implemented in a background mode for a time other than time when the incoming call or outgoing call proceeds, and may be automatically switched from the background mode to a foreground mode when the incoming call or outgoing call is generated. Furthermore, the at least one terminal (100) may include user interfaces corresponding to icons for telephone-answering message, telephone-disconnecting message and telephone-refusing message when the incoming call is generated. In this connection, in a case where the icon for telephone-refusing message has been selected, a message corresponding to the telephone-refusing message may be transmitted to a caller terminal which has generated the incoming call.

The pattern-based advertisement-managing unit (360) may collect the information about the user of the at least one terminal (100) from the at least one terminal (100) for periodic update of the information, and may record and store the collected information about the user as log data. Furthermore, the pattern-based advertisement-managing unit (360) may extract a taste pattern of the user using the at least one terminal (100) from the stored log data by the use of a learning algorithm to store the taste pattern, and may array the advertisement databases matching with the taste pattern stored in the order of priority. In this connection, the pattern-based advertisement-managing unit (360) may return to a step of displaying the advertisement based on the advertisement database and then allow the advertisement database reflecting the taste pattern to be output on the at least one terminal (100).

In addition, the call-based advertisement service-providing server (300) may allow providing of the reward point to the at least one terminal (100) through social network such as SNS and also allow the advertisement to be displayed in the at least one terminal (100) to which the reward point has been provided. Furthermore, the call-based advertisement service-providing server (300) may operate in association with web mail and thus allow a “selected” advertisement to be checked in the web mail in the at least one terminal (100), and may make a display time of advertisement screen short for repeated advertisement by counting the advertisement displayed in the at least one terminal (100). For example, the number of times and time the advertisement is displayed may be in reverse proportion to each other. Furthermore, the call-based advertisement service-providing server (300) may allow the reward point accumulated in the at least one terminal (100) to be directly applied for communication charge. For example, if the accumulated reward point is 2000, the relevant reward point may be deducted from the communication charge.

In the following, referring to FIG. 3, description will be made of an example in which a call-based advertisement service-providing method according to an embodiment of the present invention is implemented in the terminal.

Referring to FIG. 3a, (a) is a case where the incoming call is generated, (b) is a case where the incoming call or outgoing call is generated, and (c) is a case where the call has been ended. When the incoming call is generated as in (a), a user interface may be output which enables selection of refusal of reception together with the advertisement or selection of reception. When the incoming call is generated as in (b), a user interface such as call refusal icon and call disconnection icon may be output, and when the outgoing call is generated, a user interface such as span call icon, transmission voice-blocking icon, advertisement-hiding icon and call-ending icon. When the call has been ended as in (c), a user interface regarding whether to select relevant advertisement or not and a user interface regarding whether to close the relevant advertisement or not may be output.

Referring to FIG. 3b, (a) illustrates a main screen. If log-in is selected in (a), a screen such as in (b) is displayed, and if application for membership is selected in (a), a screen such as in (c) is displayed. Furthermore, if my page is selected after the application for membership or log-in, a screen such as in (d) is displayed. The service may be recommended through SNS and the like as in (e), and listed advertisements may be arrayed and displayed as in (f).

Referring to FIG. 3c, (a) illustrates a screen in which a store screen is displayed, (b) illustrates a screen in which a detailed screen is displayed when any one of the arrayed articles is selected in (a). (c) illustrates a screen for individual setting. Through it, advertised articles may be purchased from the store and also individual setting may be separately made.

FIG. 3d illustrates a procedure according to which a call-based advertisement service program according to an embodiment of the present invention is implemented. Referring to FIG. 3d, if the call-based advertisement service program is initially installed, a screen such as in (a) is displayed as a main screen, and a log-in screen such as in (b) is displayed. At this time, in a case where the application for membership is not made, a screen for application for membership such as in (c) is displayed and the information about the user of the at least one terminal (100) may be collected. At this time, if ID and password are not entered right, a screen such as in (d) or (e) may be displayed. In the my page, total accumulated money, current accumulated money and connected friends may be displayed as in (f), and selected advertisements may be listed as in (g). If the breakdown of accumulation is clicked or touched, the details of the breakdown of accumulation may be checked as in (h).

(a) of FIG. 3e is a screen for checking the breakdown of purchase, (b) is a screen displaying a function of recommending through various SNSs, and (c) illustrates a main screen displayed in the at least one terminal (100) connected through SNS. (d) illustrates service articles arrayed in the store, (e) illustrates a detailed screen of the service article selected by the user, (f) is a screen in which the advertisement database is listed, (g) illustrates a detailed screen displayed in a case where any one of advertisements has been selected in (f). and (h) illustrates a screen for setting by the user.

(a) of FIG. 3f illustrates a screen for editing a profile, (b) illustrates a user interface for receiving inquiry about advertisement tie-up from an advertiser who wants an advertisement, (c) illustrates a screen of the at least one terminal (100) which is busy after generation of the outgoing call or incoming call, (d) illustrates a user interface for deciding whether to make a call or not while the incoming call is generated, and (e) illustrates a user interface for deciding whether to select the advertisement or not after the call has been ended.

The call-based advertisement service-providing method according to an embodiment of the present invention can minimize user's feeling of repulsion toward the advertisement by inserting the advertisement in stages of call-sending, call-receiving, calling and call-ending ordinarily used. Furthermore, since the reward points for the advertisement can be accumulated even without separate operation by the user, damage caused to the user can be minimized, and accordingly continual use of the call-based advertisement service program can be ensured.

Matters regarding such a call-based advertisement service-providing method of FIGS. 2 and 3 not described above are the same as those previously described with respect to the call-based advertisement service-providing method with reference to FIG. 1 or may be easily inferred from the matters described above, and thus description thereof will be omitted in the following.

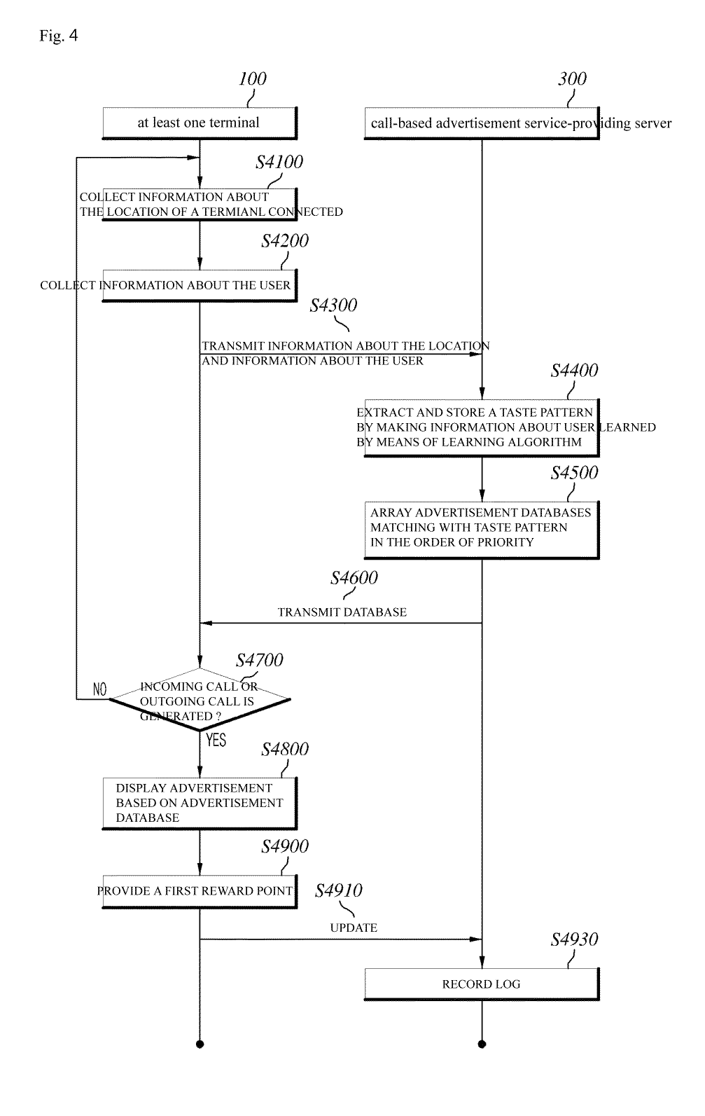

FIG. 4 is a view showing a process in which data is transmitted and received between components included in the call-based advertisement service-providing system of FIG. 1 according to an embodiment of the present invention. Hereinafter, referring to FIG. 4, description will be made of an example of the process in which signal is transmitted and received according to an embodiment of the present invention, but the present invention should not be construed to be limited to the example, and it is obvious to those skilled in the art that the process in which the data is transmitted and received as illustrated in FIG. 4 may be modified according to various embodiments previously described.

Referring to FIG. 4, the at least one terminal (100) collects the information about the location of a terminal (not shown) connected to the at least one terminal (100)(S4100), and also collects the information about the user of the at least one terminal (100)(S4200).

Then, the at least one terminal (100) transmits the information about the location and information about the user to the call-based advertisement service-providing server (300)(S4300). At this time, the information about the location and information about the user may be collected in and transmitted from the at least one terminal (100) upon request of the call-based advertisement service-providing server (300)

Furthermore, the call-based advertisement service-providing server (300) may allow the information about the user to be learned through the learning algorithm and extract the taste pattern to store it (S4400), and array the advertisement databases matching with the taste pattern in the order of priority (S4500), and then transmit the arrayed databases to the at least one terminal (100)(S4600).

Subsequently, the at least one terminal (100) determines whether the incoming call or outgoing call is generated or not (S4700). In a case where the incoming call or outgoing call is generated, the advertisement based on the advertisement database is displayed (S4800), and in a case where the call has been ended, the first reward point is provided (S4900).

Herein, the at least one terminal (100) transmits the provided first reward point as log to the call-based advertisement service-providing server (300) for update (S4910), and the call-based advertisement service-providing server (300) records the relevant log(S4930).

Matters regarding such a call-based advertisement service-providing method of FIG. 4 not described above are the same as those previously described with respect to the call-based advertisement service-providing method with reference to FIGS. 1 to 3 or may be easily inferred from the matters described above, and thus description thereof will be omitted in the following.

The order of the steps (S4100˜S4930) described above is only an example and is not limited to it. That is, the order of the steps (S4100˜S4930) described above may be mutually changed and some of the steps may be simultaneously implemented or omitted.

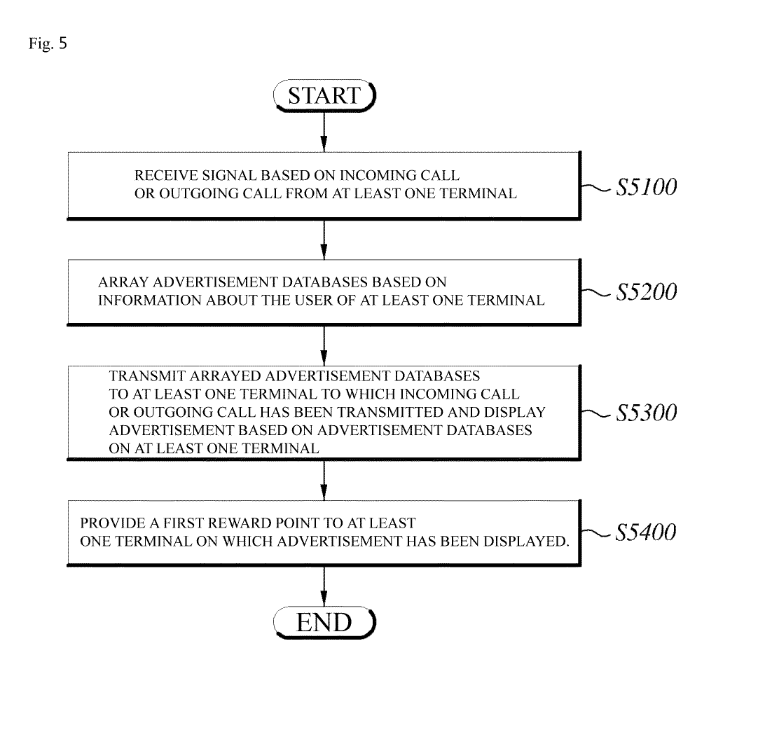

FIG. 5 is an operational flowchart for describing the call-based advertisement service-providing method according to an embodiment of the present invention. Referring to FIG. 5, the call-based advertisement service-providing server receives signal based on the incoming call or outgoing call from the at least one terminal (S5100).

Then, the call-based advertisement service-providing server arrays the advertisement databases based on the information about the user of the at least one terminal (S5200), transmits the arrayed advertisement databases to the at least one terminal to which the incoming call or outgoing call has been transmitted and allows the advertisement based on the advertisement databases to be displayed in the at least one terminal (S5300).

Finally, the call-based advertisement service-providing server provides the first reward point to the at least one terminal in which the advertisement has been displayed (S5400).

Matters regarding such a call-based advertisement service-providing method of FIG. 5 not described above are the same as those previously described with respect to the call-based advertisement service-providing method with reference to FIGS. 1 to 4 or may be easily inferred from the matters described above, and thus description thereof will be omitted in the following.

The call-based advertisement service-providing method according to an embodiment described with reference to FIG. 5 may be embodied in the form of a recording medium containing commands implementable by a computer such as application or program module which is implemented by the computer. The computer readable medium may be any available medium accessible by the computer and includes all of volatile and non-volatile medium and separable and non-separable medium. Furthermore, the computer readable medium may include all of computer storage medium and communication medium. The computer storage medium includes all of the volatile and non-volatile medium and separable and non-separable medium embodied by any method or technology for storing information such as computer readable command, data structure, program module or other data. The communication medium typically includes the computer readable command, data structure, program module or other data of modulated data signal such as carrier wave, or other transmission mechanism, and includes any information transmission medium.

The call-based advertisement service-providing method according to an embodiment of the present invention described above may be implemented by application basically installed in the terminal (the application may include program included in a platform or operating system and the like basically installed in the terminal), and may be implemented by application (i.e., program) directly installed in a master terminal by the user through application-providing server such as application store server, web server related to application or relevant service and the like. In this respect, the call-based advertisement service-providing method according to an embodiment of the present invention described above may be embodied as application (i.e., program) basically installed in the terminal or directly installed by the user and may be recorded in the recording medium which can be read by the computer such as terminal.

The above description of the present invention is illustrative, and those skilled in the art will may understand that modification into another specific form may be easily made without changing technical concepts or essential features of the present invention. Therefore, it should be understood that the embodiments described above are illustrative in all aspects and are not restrictive. For example, each component described as being unitary may be separately implemented and components described as being separate may be likewise implemented in a combined manner.

The scope of the present invention is defined by the following claims rather than the above detailed description, and all altered or modified forms derived from the meaning and scope of claims and equivalent concept thereof should be construed to be included in the scope of the present invention.

What is claimed is:

1. A advertisement service-providing method implemented by a call-based advertisement service-providing server, comprising:
a step where signal based on incoming call or outgoing call is received from at least one terminal;
a step where advertisement databases are arrayed based on information about a user including area, gender, age, marital status, preferred movie, preferred goods, and preferred service article of the user using the at least one terminal;
s step where the arrayed advertisement databases are transmitted to the at least one terminal to which the incoming call or outgoing call has been transmitted and the advertisement based on the advertisement databases is displayed on the at least one terminal;
a step where a first reward point is provided to the at least one terminal on which the advertisement has been displayed;
a step where the information about the user of the at least one terminal is collected from the at least one terminal for periodic update;
a step where the collected information about the user is recorded and stored as log data;
a step where a taste pattern of the user using the at least one terminal is extracted from the stored log data by the use of a learning algorithm and then is stored; and
a step where the advertisement databases matching with the stored taste pattern are arrayed in the order of priority,
wherein the advertisement service is provided by implementing a step where application installed in the at least one terminal registers a advertisement service-receiving receiver in OS(Operating System) of the at least one terminal; a step where whenever an advertisement database-receiving event is generated, the application receives the advertisement database; and s step where whenever the incoming call or outgoing call is generated, at least one advertisement of the advertisements contained in the received advertisement database is displayed,
wherein the at least one terminal collects information about the location of a relay, Wi-Fi device and base station connected to the at least one terminal and transmits the collected information about the location to the advertisement service-providing server, and the advertisement service-providing server receiving the collected information about the location extracts advertisement databases matching with the information about the user from the advertisement databases having the collected information about the location and arrays the advertisement databases in the at least one terminal, and the arrayed advertisement databases matching with the information about the user are listed in the order of priority and then transmitted to the at least one terminal,
wherein when the incoming call or outgoing call has been ended, the at least one terminal outputs a user interface for selecting the advertisement displayed while the incoming call or outgoing call proceeds, and a second reward point is provided when the output user interface has been selected, and log data based on the provided reward point is transmitted to the advertisement service-providing server and stored while mapped to the at least one terminal, and the second reward point is greater than the first reward point,
wherein the at least one terminal includes a user interface for setting an exposure time of the advertisement service based on the advertisement database, and the advertisement service based on the advertisement database is not exposed while the outgoing call or incoming call proceeds, for remaining time except the set exposure time,
wherein the application installed in the at least one terminal is implemented in a background mode for a time other than time when the incoming call or outgoing call proceeds, and is automatically switched from the background mode to a foreground mode when the incoming call or outgoing call is generated,
wherein the at least one terminal includes user interfaces corresponding to icons for telephone-answering message, telephone-disconnecting message and telephone-refusing message when the incoming call is generated, and in a case where the icon for telephone-refusing message has been selected, a message corresponding to the telephone-refusing message is transmitted to a caller terminal in which the incoming call has been generated,
wherein the first reward point is increased in proportion to the period, number and rate of use of the advertisement service by the user of the at least one terminal, and
wherein display time of the advertisement to be displayed on the at least one terminal is in reverse proportion to the number of times the advertisement to be displayed has been displayed.

2. A method of providing an application operating in association with an advertisement service-providing server for implementing an advertisement service-providing method, wherein the advertisement service-providing server implements the method according to claim 1.
